(19) United States
(12) Patent Application Publication
(10) Pub. No.: US 2004/0223437 A1
(43) Pub. Date: Nov. 11, 2004

(54) Optical disc playback apparatus and method for detecting mirror surface of optical disc

(75) Inventor: Hiroyuki Shiono, Gunma (JP)

Correspondence Address: SOCAL IP LAW GROUP, 310 N. WESTLAKE BLVD. STE 120, WESTLAKE VILLAGE, CA, 91362, US

(73) Assignee: Sanyo Electric Co, Ltd., Osaka (JP)

(21) Appl. No.: 10/820,965

(22) Filed: Apr. 7, 2004

(30) Foreign Application Priority Data
Apr. 8, 2003 (JP) 2003-104576

(51) Int. Cl. G11B 7/00

(52) U.S. Cl. 369/53.22; 369/53.31; 369/53.24

(57) ABSTRACT

An optical disc playback apparatus, which has an optical pickup receiving reflected light from an optical disc, comprises a signal level detector that detects a level of a signal obtained from the reflected light; and a determining circuit that, based on the level, determines which side the optical pickup is located on, an information recording area or an information non-recorded area of the optical disc.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

The present application claims priority upon Japanese Patent Application No. 2003-104576 filed on Apr. 8, 2003, which is herein incorporated by reference.

### BACKGROUND OF THE INVENTION

1. Field Of The Invention

The present invention relates to an optical disc playback apparatus and a method for detecting a mirror surface of an optical disc.

2. Description Of Related Art

Among optical discs on which data can be recorded using laser light are, for example, optical discs of a write-once type such as CD-R, and optical discs of a rewritable type such as CD-RW. As known well, areas called mirror surfaces, on which no information is recorded (information non-recorded area), are present at the innermost and outermost circumferences of an optical disc.

In an apparatus that plays back (and/or records) information from (and/or onto) such an optical disc, an optical pickup is made to track an information track by a tracking servo based on a signal read out from the information recording area of the optical disc. Refer to, for example, Japanese Patent Application Laid-open Publication No. 2000-293855.

Specifically, as shown in FIG. 1, when receiving a command from a microcomputer 500, a servo processor 600 of an optical disc playback apparatus outputs a control signal to a driver 700. Based on the control signal, the driver 700 drives a sled carrying an optical pickup 100. As a result, the optical pickup 100 moves to the lead-in area of an optical disc 10. The optical pickup 100 irradiates the optical disc 10 with laser light and receives the reflected light to read out an RF signal. According to the read-out RF signal, the servo processor 600 makes the optical pickup 100 focus on the pit surface of the optical disc 10, and thereby establishes focusing servo and tracking servo.

Then, as part of the playback processing, an RF amplifier 200 amplifies the RF signal read out by the optical pickup 100 and outputs the amplified RF signal to an A/D converter 300. The A/D converter 300 digitizes the amplified RF signal and outputs it to a DSP 400. The DSP 400 performs processes such as EFM demodulation and error correction based on the digitized RF signal to obtain a reproduced signal such as a digital audio signal. Note that this reproduced signal is converted by a D/A (digital/analog) converter into an analog signal, which is output to, for example, an audio amplifier.

However, when the optical pickup 100 is located under a mirror surface at the start, or faces a mirror surface during playback due to vibrations and the like, a problem occurs. That is, because a signal to be read out is not recorded on the mirror surface, the tracking servo does not function, so that the optical pickup operates abnormally. Furthermore, for a spindle motor rotating the optical disc, a PLL (Phase Lock Loop) generating a clock signal for controlling that rotation does not operate normally (as those say, “PLL is out of lock”). As a result, the spindle motor may run out of control.

Accordingly, by measuring time until the PLL normally operating goes out of lock, the presence of the mirror surface is detected. Hence, there is the problem that the detection of the optical pickup being located under the mirror surface is slow taking too much time.

### SUMMARY OF THE INVENTION

An optical disc playback apparatus according to one aspect of the present invention, which has an optical pickup receiving reflected light from an optical disc, comprises a signal level detector that detects a level of a signal obtained from the reflected light; and a determining circuit that, based on the level, determines which side the optical pickup is located on, an information recording area or an information non-recorded area of the optical disc.

Thus, based on the level of the signal obtained from the reflected light, it is determined which side the optical pickup is located on, an information recording area or an information non-recorded area of the optical disc. Therefore, the above-mentioned determination can be performed before proceeding to playback processing such as gain adjustment. Thus, unlike the conventional scheme which measures time until the PLL normally operating goes out of lock, the above-mentioned determination can be performed in an extremely short time.

Moreover, the determining circuit can be configured to determine that the optical pickup is located on the information non-recorded area side when the level of the signal obtained from the reflected light is less than a predetermined reference value.

The optical pickup can be configured to be moved when the optical pickup is located on the information non-recorded area side.

Thus, before the optical pickup enters abnormal operation, the spindle motor runs out of control, or the like, the optical pickup can be made to escape from the information non-recorded area of the optical disc to the information recording area in an extremely short time.

The optical disc playback apparatus can further comprise an optical pickup position detector that detects whether the optical pickup is located on an inner circumference side of the optical disc, wherein based on a detecting result of the optical pickup position detector, the optical pickup is made to move.

Thus, it can be detected whether the optical pickup is located under the information non-recorded area on the inner circumference side. And based on the detecting result, the optical pickup can be made to move. Hence, without taking a wrong movement direction, the optical pickup can be precisely and efficiently moved from the information non-recorded area to the information recording area.

Furthermore, it may be that the signal obtained from the reflected light is an RF signal, and the level is a peak-to-peak difference value of the RF signal.

Because the signal obtained from the reflected light is an RF signal, the above-mentioned determination can be performed before proceeding to playback processing such as gain adjustment. Thus, unlike the conventional scheme, which measures time until the PLL normally operating goes out of lock, the above-mentioned determination can be performed in an extremely short time.

Yet further, the determining circuit can determine the position of the optical pickup based on the level during a predetermined time period of the signal obtained from the reflected light.

Thus, erroneous determination due to noise, scratches, and the like can be avoided and thereby the above-mentioned determination can be more precise.

In a method for detecting a mirror surface of an optical disc according to the present invention, a level of a signal obtained from reflected light from an optical disc is detected, and based on the level, it is determined which side the optical pickup is located on, an information recording area or an information non-recorded area of the optical disc.

Features and objects of the present invention other than the above will become clear by reading the description of the present specification with reference to the accompanying drawings.

### DESCRIPTION OF THE DRAWINGS

For a more complete understanding of the present invention and the advantages thereof, reference is now made to the following description taken in conjunction with the accompanying drawings wherein:

FIG. 1 is a block diagram of an optical disc playback apparatus according to one embodiment of the present invention;

FIG. 2 is a block diagram of the main part of the optical disc playback apparatus according to the embodiment of the present invention;

FIG. 3 is a flow chart showing the operation of detecting a mirror surface and escape in the optical disc playback apparatus according to the embodiment of the present invention; and

FIGS. 4A and 4B are graphs representing peak-to-peak levels of an RF signal for a data area, and for the mirror surface respectively.

### DETAILED DESCRIPTION OF THE INVENTION

At least the following matters will be made clear by the description in the present specification and that of the accompanying drawings.

Entire Configuration

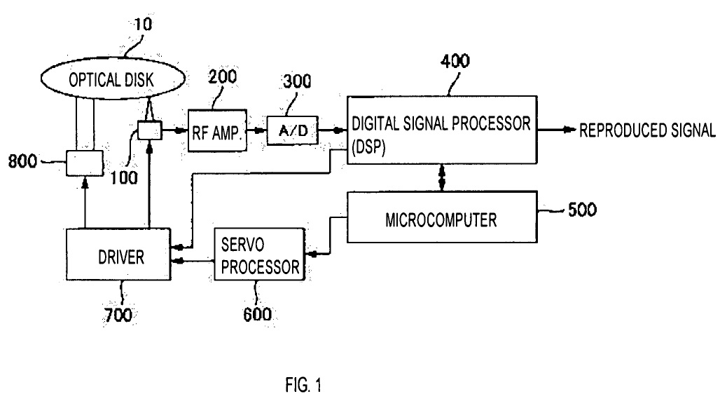

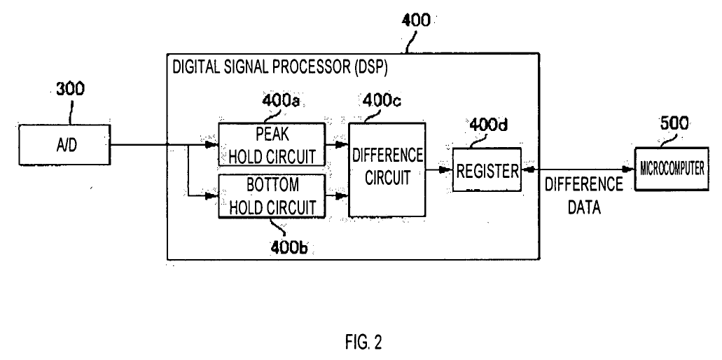

The configuration of an optical disc playback (and/or recording) apparatus according to the present embodiment will be described with reference to the block diagrams of FIGS. 1 and 2.

As shown in FIG. 1, the basic configuration of the playback apparatus for an optical disc 10, as well known, includes an optical pickup 100, an RF amplifier 200, an A/D (analog/digital) converter 300, a digital signal processor (hereinafter, called “DSP”) 400, a microcomputer (microprocessor, determining circuit, and optical pickup position detector) 500, a servo processor 600, a driver 700, and a spindle motor 800.

When receiving a command from the microcomputer 500, the servo processor 600 outputs a control signal to the driver 700. Based on the control signal, the driver 700 drives a sled carrying the optical pickup 100. As a result, the optical pickup 100 moves to the lead-in area of the optical disc 10. The optical pickup 100 irradiates the optical disc 10 with laser light and receives the reflected light to read out an RF signal. According to the read-out RF signal, the servo processor 600 makes the optical pickup 100 focus on the pit surface of the optical disc 10, and thereby establishes focusing servo and tracking servo.

Then, as part of the playback processing, the RF amplifier 200 amplifies the RF signal read out by the optical pickup 100 and outputs the amplified RF signal to the A/D converter 300. The A/D converter 300 digitizes the amplified RF signal and outputs the digitized signal to the DSP 400. The DSP 400 performs processes such as EFM demodulation and error correction based on the digitized RF signal to obtain a reproduced signal such as a digital audio signal. Note that this reproduced signal is converted by a D/A (digital/analog) converter into an analog signal, which is output to, for example, an audio amplifier.

Scheme for Detecting Mirror Surface

The optical disc playback apparatus according to the present embodiment comprises a signal level detector. The signal level detector detects the level of the RF signal obtained from the reflected light received by the optical pickup 100. As shown in FIG. 2, in the present embodiment, the signal level detector is, for example, incorporated in the DSP 400. Specifically, the signal level detector comprises a peak hold circuit 400a, a bottom hold circuit 400b, and a difference circuit 400c in order to detect the peak-to-peak difference value of the RF signal as the level of the RF signal. Note that the hold circuits 400a and 400b are constituted by registers.

For the digitized RF signal from the A/D converter 300, the peak hold circuit 400a holds a peak value (PH) thereof and the bottom hold circuit 400b holds a bottom value (BH) thereof. The difference circuit 400c obtains the difference value between the values held by both the hold circuits 400a and 400b. The difference value is stored as difference data in a register 400d, and read out by the microcomputer 500 as needed. As described later in detail, based on the read-out difference data, the microcomputer 500 determines that the optical pickup 100 is located on the mirror surface if the difference value is small and that the optical pickup 100 is located on the information recording area if the difference value is large.

Detection of Mirror Surface and Escape Operation

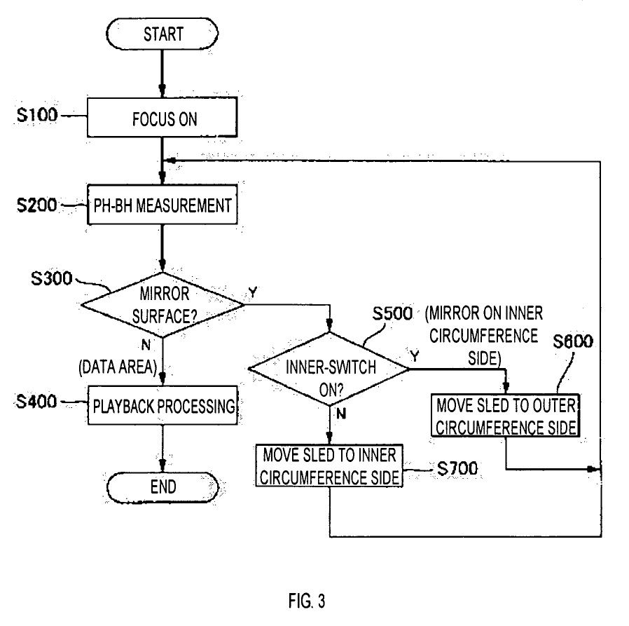

As shown in the flow chart of FIG. 3, when the optical disc playback apparatus starts to operate, focusing servo and the like are established as mentioned above, so that the focus of the optical pickup 100 is ON (S100). Next, the peak-to-peak difference value of the RF signal is measured as mentioned above (S200). Based on the difference data, the microcomputer 500 determines whether the optical pickup 100 is located on the mirror surface side or the information recording area (data area) side (S300).

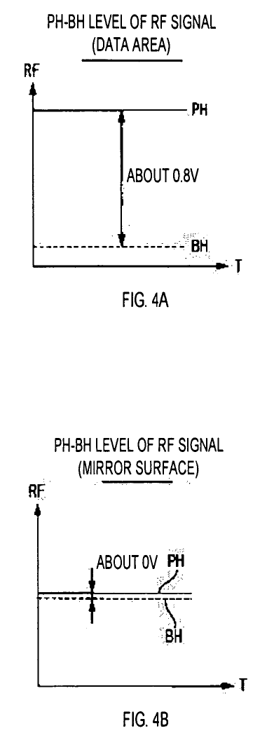

In the scheme for this determining, when the peak-to-peak difference value (level) of the RF signal is smaller than a predetermined reference value, it is determined that the optical pickup 100 is located on the mirror surface side. Conversely, when greater than the predetermined reference value, it is determined that the optical pickup 100 is located on the data area side. Specifically, as shown in the graphs of FIGS. 4A, 4B representing the peak-to-peak levels of the RF signal as an example, the difference value between the peak value (PH) and the bottom value (BH) is about 0.8 volts in the case of the data area shown in FIG. 4A. On the other hand, in the case of the mirror surface shown in FIG. 4B, the difference value between the peak value (PH) and the bottom value (BH) is about 0 volts. Accordingly, in order to be able to distinguish both the difference values certainly, the reference value is set at, for example, 0.2 volts. This reference value is recorded beforehand in ROM or the like of the microcomputer 500. That is, when the difference value is greater than the reference value of 0.2 volts, it is determined to be the data area, and conversely when the difference value is smaller, it is determined to be the mirror surface.

And if it is determined not to be the mirror surface as a result of the determining process of S300 (S300: NO), the above-mentioned playback processing is executed (S400). On the other hand, if it is determined to be the mirror surface (S300: YES), the microcomputer 500 confirms whether an inner switch is ON (S500). The inner switch is a known mechanical switch for indicating whether the optical pickup 100 is located on the inner circumference side of the optical disc 10. This inner switch is placed, for example, at such a position that the optical pickup 100 touches it while moving along the rail of the sled. The inner switch is ON when the optical pickup 100 is facing the innermost circumference of the optical disc 10, and on the other hand, is OFF when the optical pickup 100 has moved away from the innermost circumference side of the optical disc 10. That is, the microcomputer 500, in the operation of detecting the position of the optical pickup 100, monitoring the state of the inner switch, determines that the position of the optical pickup 100 is on the inner circumference side, when it is ON. On the other hand, when it is OFF, it determines that the position of the optical pickup 100 is not on the inner circumference side. Therefore, in S500, when the inner switch is ON (S500: YES), the microcomputer 500 determines that the position of the optical pickup 100 is on the mirror surface on the inner circumference side of the optical disc 10 and moves the sled towards the outer circumference side of the optical disc 10. As a result, the optical pickup 100 moves from the inner circumference side towards the outer circumference side (S600). By this means, the optical pickup 100 moves in an appropriate direction to escape from the mirror surface. Then, the process returns to S200, which confirms whether the optical pickup 100 has escaped from the mirror surface.

On the other hand, when the inner switch is not ON (S500: NO), the microcomputer 500 determines that the position of the optical pickup 100 is on the mirror surface on the outer circumference side of the optical disc 10 and moves the sled towards the inner circumference side of the optical disc 10. As a result, the optical pickup 100 moves from the outer circumference side towards the inner circumference side (S700). By this means, the optical pickup 100 moves in an appropriate direction to escape from the mirror surface. Then, the process returns to S200, which confirms whether the optical pickup 100 has escaped from the mirror surface. By repeating these processes S200 to S700, when located on the mirror surface, the optical pickup 100 is made to escape.

Measure for Noise Signal, Scratches, and the like

In case a noise signal is recorded on an optical disc, or scratches or dust is sticking thereto, a measure is taken to prevent the occurrence of erroneous determination of whether the optical pickup 100 is located on the mirror surface as mentioned above. That is, the microcomputer 500 determines based on the difference data acquired during a time period of, e.g., about 20 milliseconds when detecting a mirror surface based on the difference value between the peak value and the bottom value in S300 of FIG. 3 mentioned above.

That is, it is hard to imagine that difference data affected by a noise signal, scratches, or dust maintains a certain value beyond the time period of about 20 milliseconds, corresponding to ¼ to ⅓ of the rotation of the optical disc 10. Therefore, while ignoring difference data that fluctuates for less than 20 milliseconds centering around the reference value, it is determined whether the optical pickup is facing a mirror surface based on stable difference data that continues to be above or below the reference value for 20 milliseconds or longer. Specifically, the microcomputer 500 reads out difference data of the register 400d at a predetermined sampling cycle for 20 milliseconds to perform determination of a mirror surface.

Based on the level of the signal obtained from the reflected light, it is determined which side the optical pickup is located on, the information recording area or the information non-recorded area of the optical disc. Therefore, the above-mentioned determination can be performed before proceeding to playback processing such as gain adjustment. Thus, unlike the conventional scheme, which measures time until the PLL normally operating goes out of lock, the above-mentioned determination can be performed in an extremely short time.

Although the preferred embodiment of the present invention has been described in detail, it should be understood that various changes, substitutions and alterations can be made therein without departing from the spirit and scope of the invention as defined by the appended claims.

It is claimed:

1. An optical disc playback apparatus which has an optical pickup receiving reflected light from an optical disc, comprising:
a signal level detector that detects a level of a signal obtained from said reflected light; and
a determining circuit that based on said level determines which side said optical pickup is located on, an information recording area or an information non-recorded area of said optical disc.

2. The optical disc playback apparatus according to claim 1, wherein when said level of said signal obtained from said reflected light is less than a predetermined reference value, said determining circuit determines that said optical pickup is located on said information non-recorded area side.

3. The optical disc playback apparatus according to claim 1, wherein when said optical pickup is located on said information non-recorded area side, said optical pickup is made to move.

4. The optical disc playback apparatus according to claim 2, wherein when said optical pickup is located on said information non-recorded area side, said optical pickup is made to move.

5. The optical disc playback apparatus according to claim 3, further comprising:
an optical pickup position detector that detects whether said optical pickup is located on an inner circumference side of said optical disc,
wherein based on a detecting result of said optical pickup position detector, said optical pickup is made to move.

6. The optical disc playback apparatus according to claim 4, further comprising:
an optical pickup position detector that detects whether said optical pickup is located on an inner circumference side of said optical disc,
wherein based on a detecting result of said optical pickup position detector, said optical pickup is made to move.

7. The optical disc playback apparatus according to claim 1, wherein said signal obtained from said reflected light is an RF signal, and said level is a peak-to-peak difference value of the RF signal.

8. The optical disc playback apparatus according to claim 2, wherein said signal obtained from said reflected light is an RF signal, and said level is a peak-to-peak difference value of the RF signal.

9. The optical disc playback apparatus according to claim 3, wherein said signal obtained from said reflected light is an RF signal, and said level is a peak-to-peak difference value of the RF signal.

10. The optical disc playback apparatus according to claim 4, wherein said signal obtained from said reflected light is an RF signal, and said level is a peak-to-peak difference value of the RF signal.

11. The optical disc playback apparatus according to claim 5, wherein said signal obtained from said reflected light is an RF signal, and said level is a peak-to-peak difference value of the RF signal.

12. The optical disc playback apparatus according to claim 6, wherein said signal obtained from said reflected light is an RF signal, and said level is a peak-to-peak difference value of the RF signal.

13. The optical disc playback apparatus according to any one of claims 1 to 12, wherein said determining circuit determines the position of said optical pickup based on the level of said signal obtained from said reflected light during a predetermined time period.

14. A method for detecting a mirror surface of an optical disc, wherein a level of a signal obtained from reflected light from an optical disc is detected, and based on said level, it is determined which side said optical pickup is located on, an information recording area or an information non-recorded area of said optical disc.
